(19) United States
(12) Patent Application Publication
(10) Pub. No.: US 2024/0136558 A1
(43) Pub. Date: Apr. 25, 2024

(54) CHLORIDE-FREE ELECTROLYTE COMPOSITION FOR PROLONGED OPERATION AT HIGH TEMPERATURES (>40°C) IN VANADIUM REDOX FLOW BATTERIES

(71) Applicant: FRAUNHOFER-GESELLSCHAFT ZUR FÖRDERUNG DER ANGEWANDTEN FORSCHUNG e. V., München (DE)

(72) Inventors: Nataliya Roznyatovskaya, Pfinztal-Berghausen (DE); Peter Fischer, Pfinztal-Berghausen (DE)

(21) Appl. No.: 18/381,322

(22) Filed: Oct. 17, 2023

(30) Foreign Application Priority Data
Oct. 24, 2022 (DE) 102022128209.0

(51) Int. Cl. H01M 8/086; H01M 8/18

(52) U.S. Cl. CPC H01M 8/086; H01M 8/188

(57) ABSTRACT

An electrolyte solution for a vanadium redox flow battery, wherein the electrolyte solution comprises vanadium ions, sulfate ions, and phosphoric acid; and further wherein the conductivity a of the electrolyte solution is in the range of 280 mS·cm⁻¹ to 420 mS·cm⁻¹.

### SUMMARY

The present invention relates to an electrolyte composition for a vanadium redox flow cell or battery that remains stable at temperatures above 40° C. for an extended period of time.

### TECHNICAL BACKGROUND

Redox flow (FB) batteries are widely used to store electrical energy generated from renewable sources to compensate for the unsteadiness of these energy sources.

The outstanding feature of vanadium redox flow batteries (VFB) is the use of an aqueous vanadium sulfate solution in both half cells as the electrolyte solution. Therefore, even if the two electrolytes are mixed, no contamination of the respective solutions occurs. When discharging and charging the battery, the property of vanadium to form redox pairs in the oxidation states (II) and (III), as well as (IV) and (V) is exploited. Equilibrium equation (i) describes the oxidation and reduction reactions occurring in the positive electrolyte (electrolyte of the half-cell for the positive terminal) during charging and discharging, and equation (ii) describes the oxidation and reduction reactions occurring in the negative electrolyte (electrolyte of the half-cell for the negative terminal) during charging and discharging of the battery.

$${VO}^{2 +} + {H}_{2} O {{⇌}_{Discharging}}^{Charging} {VO}_{2}^{+} + 2 {H}^{+} + {e}^{-} \qquad ( i )$$

$${V}^{3 +} + {e}^{-} {{⇌}_{Discharging}}^{Charging} {V}^{2 +} \qquad ( ii )$$

U.S. Pat. No. 4,786,567 describes an electrolyte composition for a VFB consisting of vanadium ions, sulfate ions and sulfuric acid.

U.S. Pat. No. 7,258,947 B2 describes an electrolyte characterized by containing impurities of ammonium ions and silicon only in low ppm ranges and phosphoric acid as a stabilizer.

One problem of VFBs is the instability of the positive electrolyte solutions (i) at elevated temperatures. This is mainly due to the fact that the divanadyl cation VO₂⁺, which is present in the fully charged battery as the main component of the positive electrolyte, is thermodynamically stable only at low concentrations, and at higher concentrations and temperatures precipitates via several polymeric intermediates as vanadium (V) oxide V₂O₅, as described in the reaction equation (iii).

2VO₂⁺+H₂O⇄V₂O₅↓+2H⁺ (iii)

Vanadium redox flow batteries (VFB) are therefore generally operated at electrolyte temperatures in a temperature range of 5° C. to 40° C.

Since the electrolyte in vanadium redox flow batteries can heat up to 50° C. during discharge, depending on the current load, and since ambient temperatures in some areas of the world can also rise above 40° C. for extended periods, the electrolyte in technical storage systems is actively cooled in the case of a fully charged battery. This is done to prevent irreversible precipitation of vanadium (V) oxide. However, this cooling reduces the overall efficiency of the storage system.

Previous approaches to stabilizing the electrolyte solution at elevated temperatures dealt with the addition of additives to the electrolyte solution.

Stabilization of divanadyl cation VO₂⁺ by chloride ions is known from U.S. Pat. No. 9,819,039 B2, and from publications L. Li, S. Kim, W. Wang, M. Vijayakumar, Z. Nie, Baowei Chen, J. Zhang, G. Xia, J. Hu, G. Graff, J. Liu, Z. Yang, Adv. Energy Mater. 2011, 1, 394-400 and M. Vijayakumar et al, Chem. Plus Chem. 2015, 80, 428-437.

Other additives for vanadium electrolyte solutions are disclosed in U.S. Pat. No. 6,562,514 B1 and U.S. Pat. No. 10,673,090 B2.

U.S. Pat. No. 6,468,688 B2 describes a vanadium electrolyte solution stabilized by additives such as potassium sulfate, sodium hexametaphosphate and polyacrylic acid, but only allows use at a temperature above 35° C.

A disadvantage of adding additives, such as chloride ions to the electrolyte solution for a vanadium redox flow battery is the change in electrolyte composition due to oxidation (chlorine evolution) or degradation of the additive when operated for an extended period of time.

Another problem with vanadium sulfate electrolyte solutions for VFBs is that the exact actual composition of the electrolyte solution cannot be directly determined.

The electrolyte solution for all-vanadium redox flow batteries in commercial systems consists of a 1:1 molar mixture of vanadium(III) and vanadium(IV) ions, with total vanadium ion concentrations in the range of 1.5-1.8 mol·L⁻¹ in the electrolyte solutions, depending on the manufacturer. The solutions are obtained by dissolving vanadium oxides in medium-concentrated sulfuric acid (3-5 mol·L⁻¹), so that the concentration of “free” sulfuric acid in the electrolyte solutions is approximately 1.7-2.5 mol·L⁻¹. However, the exact actual composition of the dissociated acid in an electrolyte cannot be determined directly because the anions, depending on the preparation process by chemical or electrochemical dissolution, are present as a mixture of sulfates and hydrogen sulfate, and side reactions, such as dimerization of the vanadium species, affect the proton concentration. Only the total sulfate ion concentration can be determined experimentally.

Even though the concentration of the “free” acid in the electrolyte solutions is practically not measurable, the electrolyte conductivity a can be used as an evaluation criterion. The conductivity of the electrolytes is a measurable parameter that is proportional to the concentration of the “free” acid in the electrolyte at constant total vanadium and total sulfate concentrations. Thus, at a constant temperature, a high conductivity of the electrolyte solution corresponds to a high “free” acid concentration.

An electrolyte composition that enables stable vanadium flow battery operation, both at 0° C. and above 40° C., and is characterized by its conductivity for better feasibility is desirable.

In the course of intensive research work in this field, an electrolyte composition has now been found which allows stable operation of the VFB for a longer period of time even at temperatures above 40° C., does not require chloride as an additive and is characterized by comprising vanadium ions, sulfate ions and phosphate ions, with a low ratio of vanadium ions to sulfate ions and a high conductivity of the electrolyte solution.

### DESCRIPTION OF THE INVENTION

The present invention relates to an aqueous electrolyte solution for a vanadium redox flow battery, characterized in that the electrolyte solution comprises
(a) vanadium ions at a concentration C_{V} in the range of 1.10 mol·L⁻¹ to 1.70 mol·L⁻¹,
(b) sulfate ions at a concentration C_{S} in the range of 4.10 mol·L⁻¹ to 4.90 mol·L⁻¹; and
c) phosphoric acid at a concentration C_{P} in the range of 0.01 mol·L⁻¹ to 0.20 mol·L⁻¹;
   wherein the conductivity a of the electrolyte solution is in the range of 280 mS·cm⁻¹ to 420 mS·cm⁻¹.

An aqueous solution in the sense of the present invention is a homogeneous solution comprising water and substances, liquids and gases dissolved therein.

The electrolyte solution according to the invention can be obtained by mixing the appropriate amounts of vanadium sulfates, sulfuric acid and phosphoric acid. Preferably, the electrolyte solution according to the invention is obtained by adding sulfuric acid and/or phosphoric acid to, and/or by diluting with water, commercial aqueous vanadium electrolyte solutions.

Commercial vanadium electrolyte solutions are usually prepared by dissolving vanadium oxides in medium-concentrated sulfuric acid (3-5 mol·L⁻¹).

The sulfate ions in these solutions therefore originate mainly from vanadium sulfates and the remaining “free” sulfuric acid. Since the electrolyte solutions vary greatly in their exact composition of vanadium and sulfate ions depending on the manufacturer and the method of production, the vanadium ion and sulfate ion concentrations must be determined experimentally. Only then can the exact quantities of sulfuric acid and water required be calculated in order to arrive at the desired concentrations of the inventive electrolyte solutions.

The high concentration of sulfuric acid, which is indirectly measured by the high conductivity of the electrolyte solutions, results in better stabilization of the divanadyl cation due to the lower pH, and the high concentration of sulfate ions stabilizes the vanadium species by complex formation.

The electrolyte solution of the present invention comprises sulfate ions at a concentration C_{S} in the range of 4.10 mol·L⁻¹ to 4.90 mol·L⁻¹, preferably in the range of 4.20 mol·L⁻¹ to 4.80 mol·L⁻¹, and more preferably in the range of 4.30 mol·L⁻¹ to 4.70 mol·L⁻¹.

Typically, vanadium concentrations of commercial electrolyte solutions are in the range of 1.5-1.8 mol·L⁻¹. In the present invention, the electrolyte solution comprises vanadium ions at a concentration C_{V} in the range of 1.10 mol·L⁻¹ to 1.70 mol·L⁻¹, preferably in the range of 1.20 mol·L⁻¹ to 1.60 mol·L⁻¹, and more preferably in the range of 1.30 mol·L⁻¹ to 1.50 mol·L⁻¹.

The lower vanadium ion concentration increases the temperature stability of the charged electrolyte solution, since the stability of the divanadyl cation VO₂ is concentration dependent The high sulfate ion concentration and the lower vanadium ion concentration result in a relatively small ratio of the vanadium ion concentration C_{V} to the sulfate ion concentration C_{S} (C_{V}/C_{S}). In a preferred embodiment of the electrolyte solution, the ratio C_{V}/C_{S} is in the range of 0.27 to 0.33. In a particularly preferred embodiment of the electrolyte solution, the ratio C_{V}/C_{S} is in the range of 0.29 to 0.32.

As a further parameter for characterizing the electrolyte solutions, the conductivity a is measured. Thus, an indirect statement can be made about the “free” sulfuric acid concentration and the inventive electrolyte solution can be characterized. Electrolyte compositions comprising the disclosed vanadium ion, sulfate ion, and phosphoric acid concentrations, but having lower conductivity (\hat{=}less “free” sulfuric acid) because the sulfate ion concentration has been increased by addition of other sulfate salts such as ammonium sulfate, can thus be distinguished from the inventive electrolyte solution. The conductivity a of the inventive electrolyte solution is in the range of 280 mS·cm⁻¹ to 420 mS·cm⁻¹, preferably in the range of 310 mS·cm⁻¹ to 390 mS·cm⁻¹, and more preferably in the range of 330 mS·cm⁻¹ to 380 mS·cm⁻¹.

By adding a calculated amount of phosphoric acid to the electrolyte solution, the desired phosphoric acid concentration in the electrolyte solution can be adjusted. Phosphoric acid prevents polymerization of vanadium pentoxide V₂O₅, by stopping the polymerization at a certain degree of polymerization through the formation of phosphato-vanadate compounds.

The electrolyte solution according to the present invention comprises phosphoric acid at a concentration C_{P} in the range of 0.01 mol·L⁻¹ to 0.20 mol·L⁻¹, preferably in the range of 0.05 mol·L⁻¹ to 0.15 mol·L⁻¹, wherein the concentration C_{P} in the electrolyte solution is indirectly determined by the amount of added phosphoric acid.

Accordingly, the present invention relates to an aqueous electrolyte solution for a vanadium redox flow battery, characterized in that the electrolyte solution comprises
(a) vanadium ions at a concentration C_{V} in the range of 1.10 mol·L⁻¹ to 1.70 mol·L⁻¹,
(b) sulfate ions at a concentration C_{S} in the range of 4.10 mol·L⁻¹ to 4.90 mol·L⁻¹; and
c) phosphoric acid at a concentration C_{P} in the range of 0.01 mol·L⁻¹ to 0.20 mol·L⁻¹;
   wherein the conductivity a of the electrolyte solution is in the range of 280 mS·cm⁻¹ to 420 mS·cm⁻¹;
   wherein the vanadium ion concentration C_{V}, sulfate ion concentration C_{S} and conductivity a are determined by direct measurement of the electrolyte solution and the concentration of phosphoric acid C_{P} is determined indirectly via the amount of phosphoric acid added.

Combinations of preferred and non-preferred concentrations, ratios and conductivities of the electrolyte solutions are encompassed within the meaning of the present invention.

In one embodiment according to the invention, the electrolyte solution comprises vanadium ions at a concentration C_{V} in the range of 1.30 mol·L⁻¹ to 1.50 mol·L⁻¹ and has a ratio C_{V}/C_{S} in the range of 0.27 to 0.33.

In another embodiment, the electrolyte solution comprises vanadium ions at a concentration C_{V} in the range of 1.30 mol·L⁻¹ to 1.50 mol·L⁻¹ and sulfate ions at a concentration C_{S} in the range of 4.30 mol·L⁻¹ to 4.70 mol·L⁻¹.

In another embodiment, the electrolyte solution comprises sulfate ions at a concentration C_{S} in the range of 4.30 mol·L⁻¹ to 4.70 mol·L⁻¹ and a ratio C_{V}/C_{S} in the range of 0.27 to 0.33.

A preferred embodiment of the electrolyte solution comprises.
(a) vanadium ions at a concentration C_{V} in the range of 1.30 mol·L⁻¹ to 1.50 mol·L⁻¹,
(b) sulfate ions at a concentration C_{S} in the range of 4.30 mol·L⁻¹ to 4.70 mol·L⁻¹; and
(c) phosphoric acid at a concentration C_{P} in the range of 0.05 mol·L⁻¹ to 0.15 mol·L⁻¹;
   and has a conductivity a in the range of 310 mS·cm⁻¹ to 390 mS·cm⁻¹.

A particularly preferred embodiment of the electrolyte solution comprises
(a) vanadium ions at a concentration C_{V} of 1.40 mol·L⁻¹,
b) sulfate ions at a concentration C_{S} of 4.40 mol·L⁻¹; and
(c) phosphoric acid at a concentration C_{P} of 0.10 mol·L⁻¹;
   and has a conductivity a of 340 mS·cm⁻¹.

The electrolyte solution according to the invention was primarily developed to be used in a vanadium redox flow battery. Therefore, the present invention relates to a vanadium redox flow battery, characterized in that it comprises one of the electrolyte solutions according to the invention.

The electrolyte solution can be used in the half cell with the positive terminal, the half cell with the negative terminal, as well as in both half cells.

The high thermal stability of the developed electrolyte solution allows an operating temperature range of the corresponding vanadium redox flow battery from 0° C. to 60° C.

Since heat is generated when the vanadium redox flow battery is discharged, a high, possible operating temperature is of great importance to ensure long system operation.

### Experimental Part

Measurement Methods:

Determination of Vanadium Ions and Sulfate Ions Concentrations

The vanadium ion concentration C_{V} and the molar ratio of vanadium ions in different oxidation states were determined by potentiometric titration with a 0.1 M cerium(IV) sulfate standard solution (Carl-Roth, Germany). The titration was performed with a T70 automatic titrator (Mettler Toledo Int. Inc., Germany).

A classical gravimetric method based on precipitation with barium chloride was used to determine the sulfate ion concentration C_{S}.

Measurement Method for Determining the Conductivity σ

The conductivity a of the electrolyte solution was determined by measuring with an AC impedance technique in a four-electrode glass cell with a cell constant of 7.3 cm⁻¹ and glassy carbon or graphite electrodes. High-frequency resistance values were measured in a frequency range of 10 to 100 kHz with an alternating current AC of 10 mA and a direct current DC of 0 mA. A standard solution with a conductivity of 500 mS·cm⁻¹ was used for calibration of the cell.

Ex-Situ Measurement of Temperature Stability

The thermal stability of the charged positive electrolyte solutions was tested by transferring 1 mL of the respective electrolyte solution into a vial and exposing it to a preset temperature in a test chamber (Weiss WKL 64, Germany) for 3 days. The temperature was gradually increased from 40° C. to 50° C., from 50° C. to 55° C., from 55° C. to 60° C., and from 60° C. to 65° C. after each 3-day period, and the electrolyte solutions were visually inspected after each step for signs of degradation such as precipitation, sediment formation, and color change.

Charging the Electrolyte Solution

A galvanostatic-potentiostatic mode with a maximum voltage of 1.65 V and a maximum current of 3 A was applied to charge a cell with electrolyte solution, whereby the end-of-charge voltage for the galvanostatic step was set at 1.65 V with 75 mA-cm⁻² and then the cut-off current was 10 mA-cm⁻² at an applied voltage of 1.65 V.

At the full charge state (100%), the vanadium ions of the positive electrolyte solution are present exclusively in the oxidation state (V). At a state of charge of 97%, 97% of the vanadium ions of the positive electrolyte solution are present in the oxidation state (V) and 3% in the oxidation state (IV).

Production of the Electrolyte Solutions:

The comparative vanadium electrolyte solutions CE1 and CE2 were obtained commercially and consisted of V(III) and V(IV) sulfates, sulfuric acid, phosphoric acid and water. The concentration of vanadium ions C_{V} and sulfate ions C_{S} was determined. The concentration of phosphoric acid C_{P} was taken from the data sheet of the electrolyte solutions obtained commercially.

TABLE 1
Concentrations of the electrolyte solutions CE1 and CE2.

| | CE1 | | CE2 | |
|---|---|---|---|---|
| | V(III) = | V(IV) = | V(III) = | V(IV) = |
| Molar composition [% Cv] | 48.3 | 51.7 | 43.6 | 56.4 |

| | | |
|---|---|---|
| C_{V} [mol · L⁻¹] | 1.68 | 1.56 |
| C_{S} [mol · L⁻¹] | 3.8 | 4.0 |
| C_{P} [mol · L⁻¹] | 0.05 | 0.1 |

The inventive electrolyte compositions IE1-IE3 were prepared by adding water, concentrated sulfuric acid and concentrated phosphoric acid to the commercially available vanadium electrolyte solution VET.

The inventive electrolyte composition IE4 was prepared by adding water, concentrated sulfuric acid and concentrated phosphoric acid to the commercially available vanadium electrolyte solution CE2.

The conductivities a of the electrolyte solutions were measured.

TABLE 2
Concentrations and conductivities of the electrolyte
solutions IE1-IE4 and CE1-CE2.

| | IE1 | IE2 | IE3 | IE4 | CE1 | CE2 |
|---|---|---|---|---|---|---|
| C_{V} [mol · L⁻¹] | 1.43 | 1.43 | 1.32 | 1.41 | 1.68 | 1.56 |
| C_{S} [mol · L⁻¹] | 4.7 | 4.7 | 4.3 | 4.5 | 3.8 | 4.0 |
| C_{P} [mol · L⁻¹] | 0.05 | 0.1 | 0.1 | 0.09 | 0.05 | 0.1 |
| σ [mS · cm⁻¹] | 345 | 346 | 378 | 345 | 240 | 295 |

Temperature Stability of the Positive Electrolyte:

The V(III) and V(IV) ions in the electrolyte solutions IE1-IE4 and CE1-CE2 were converted by electrolysis into the redox pairs V(IV) and V(V) for the positive electrolyte solutions.

A galvanostatic-potentiostatic mode with a maximum voltage of 1.65 V and a maximum current of 3 A was used to bring cells with the respective electrolyte solutions to a state of charge of 97% or more. The end-of-charge voltage for the galvanostatic step was set at 1.65 V with 75 mA-cm⁻² and then the cut-off current was 10 mA-cm⁻² at an applied voltage of 1.65 V.

To test the thermal stability of the charged positive electrolyte solutions, 1 mL of each electrolyte solution was transferred to a vial and exposed to a preset temperature in a test chamber (Weiss WKL 64, Germany) for 3 days. The temperature was gradually increased from 40° C. to 50° C., from 50° C. to 55° C., from 55° C. to 60° C., and from 60° C. to 65° C. after each 3-day period, and the electrolyte solutions were visually inspected after each step for signs of degradation such as precipitation, sediment formation, and color change.

TABLE 3
Temperature stabilities of the charged electrolyte
solutions IE1*-IE4* and CE1*-CE2*.

| | IE1* | IE2* | IE3* | IE4* | CE1* | CE2* |
|---|---|---|---|---|---|---|
| Temperature | 60° C. | 60° C. | 60° C. | 55° C. | 40° C. | 40° C. |
| stability | (98%) | (98%) | (99%) | (98%) | (99%) | (97%) |
| (state of | | | | | | |
| charge) | | | | | | |
| Temperature | 65° C. | 65° C. | 65° C. | 65° C. | 50° C. | 55° C. |
| stability | (80%) | (80%) | (80%) | (80%) | (80%) | (80%) |
| (state of | | | | | | |
| charge) | | | | | | |

The fully charged (state of charge≥97%) electrolyte solutions IE1*-IE3* showed no signs of degradation after 3 days at 60° C. and IE4* after 3 days at 55° C.

This is a significant improvement over the comparative solutions CE1* and CE2*, which were stable only up to 40° C. and were already thermally unstable at 50° C.

At a state of charge of 80%, the inventive electrolyte solutions IE1*-IE4* showed no signs of degradation even after 3 days at 65° C. The electrolyte solutions CE1* and CE2* with the same state of charge, on the other hand, were stable only up to 50° C. and 55° C., respectively.

In addition, the charged electrolyte solutions IE1*-IE4* showed no signs of instability, such as crystallization, at temperatures as low as −20° C.

Furthermore, the electrolyte solutions IE1-IE4 have higher conductivity and can thus improve the energy efficiency of the VFBs, since less energy is lost due to ohmic losses.

1. An aqueous electrolyte solution for a vanadium redox flow battery, wherein the electrolyte solution comprises;
a) vanadium ions at a concentration C_{V} in a range of 1.10 mol·L⁻¹ to 1.70 mol·L⁻¹,
b) sulfate ions at a concentration C_{S} in a range of 4.10 mol·L⁻¹ to 4.90 mol·L⁻¹ and
c) phosphoric acid at a concentration Cₚ in a range of 0.01 mol·L⁻¹ to 0.20 mol·L⁻¹;
wherein the conductivity a of the electrolyte solution is in a range of 280 mS·cm⁻¹ to 420 mS·cm⁻¹.

2. The electrolyte solution according to claim 1, wherein the ratio C_{V}/C_{S} of the vanadium ion concentration C_{V} to the sulfate ion concentration C_{S} is in a range of 0.27 to 0.33.

3. The electrolyte solution according to claim 1, wherein the concentration C_{V} of vanadium ions is in the range of 1.20 mol·L⁻¹ to 1.60 mol·L⁻¹.

4. The electrolyte solution according to claim 1, wherein the concentration C_{S} of sulfate ions is in the range of 4.20 mol·L⁻¹ to 4.80 mol·L⁻¹.

5. The electrolyte solution according to claim 1, wherein the concentration Cr of phosphoric acid is in the range of 0.05 mol·L⁻¹ to 0.15 mol·L⁻¹.

6. The electrolyte solution according to claim 1, wherein the conductivity a of the electrolyte solution is in the range of 310 mS·cm⁻¹ to 390 mS·cm⁻¹.

7. A vanadium redox flow battery comprising the electrolyte solution according to claim 1.

8. The vanadium redox flow battery of claim 7, wherein the operating temperature is in the range of 0° C. to 60° C.
